(19) United States
(12) Patent Application Publication
(10) Pub. No.: US 2005/0039208 A1
(43) Pub. Date: Feb. 17, 2005

(54) Wireless data communications system for a transportation vehicle

(75) Inventors: David C. Veeck, North Bend, WA (US); Michael S. Hettich, Woodinville, WA (US); Edward H. Hsieh, Redmond, WA (US); Michael M. Mowry, Redmond, WA (US)

Correspondence Address: HOWREY SIMON ARNOLD & WHITE LLP, ATTEN: MARGARET P. DROSOS, DIRECTOR OF IP ADMIN, 2941 FAIRVIEW PARK DR, BOX 7, FALLS CHURCH, VA, 22042, US

(73) Assignee: General Dynamics OTS (Aerospace), Inc.

(21) Appl. No.: 10/154,791

(22) Filed: May 24, 2002

Related U.S. Application Data
(60) Provisional application No. 60/328,951, filed on Oct. 12, 2001.

(51) Int. Cl. H04N 7/18

(52) U.S. Cl. 725/76; 725/74; 725/80; 725/81

(57) ABSTRACT

A wireless communication system for a transportation vehicle such as, for example, an aircraft, bus, cruise ship, and train, is presented. The wireless communication system includes an information source containing data content including text, audio and video media, a plurality of wireless interfaces, a plurality of individually identifiable electronic devices coupled to the plurality of wireless interfaces and a wireless local area network (LAN) access point. The wireless LAN access point is coupled to the information source and wirelessly coupled to the plurality of wireless interfaces. In operation, the wireless LAN access point receives data content from the information source, converts the data content into a wireless transmission format and selectively distributes the formatted data content to the plurality of wireless interfaces such that the formatted data content is accessible by at least a selected one of the plurality of individually identifiable electronic devices.

### CROSS REFERENCE TO RELATED APPLICATIONS

Priority is herewith claimed under 35 U.S.C. §119(e) from copending U.S. Provisional Patent Application Ser. No. 60/328,951, filed Oct. 12, 2001, entitled “WIRELESS DATA COMMUNICATIONS SYSTEM FOR A TRANSPORTATION VEHICLE”, by David C. Veeck et al. The disclosure of this U.S. provisional patent application is incorporated by reference herein in its entirety.

### FIELD OF THE INVENTION

This invention relates generally to systems and methods for wireless communication of data to a plurality of user devices and, particularly, for the wireless communication of data to on-board components and passenger devices located in commercial passenger transportation vehicles such as, for example, aircraft, buses, cruise ships, trains and the like.

### BACKGROUND OF THE INVENTION

As described in commonly-assigned U.S. Pat. No. 6,249,913, issued Jun. 19, 2001, entitled “AIRCRAFT DATA MANAGEMENT SYSTEM,” by Stephen R. Galipeau et al., passengers seated on transportation vehicles may wish to pass travel time by requesting and reviewing a range of information such as video, audio and internet data. Galipeau et al. describe a data management system for distributing data to passengers on-board transportation vehicles such as, for example, an aircraft. The disclosure of this U.S. patent is incorporated by reference herein in its entirety.

Some other data systems utilized on transportation vehicles include the following: U.S. Pat. No. 4,428,078, issued Jan. 24, 1984, entitled “WIRELESS AUDIO PASSENGER SYSTEM (WAPES)”, by Chyi J. Kuo, discloses an aircraft passenger entertainment system utilizing simultaneous transmission of low frequency signals for power supply rectification and radio frequency (RF) signals for providing entertainment information (e.g., audio signals) to a receiver within passenger seats. A transmitter of the entertainment system utilizes a balanced twin lead transmission line that is located within a cabin floor portion of a fuselage and is coupled to pick up loops within seat tracts. German Patent No. DE3719105, published Dec. 22, 1988, discloses an aircraft passenger seat in which communication elements such as receiver components, loud speakers, video connections, control elements and reading lamps, are integrated. The communication and control elements are part of an information system having an energy source that is allocated to each specific seat for powering the components. The components are described as receiving parts of the information system, which are said to receive information from the information system in a “wire-free manner”. U.S. Pat. No. 6,014,381, issued Jan. 11, 2000, entitled “SYSTEM AND METHOD FOR DISTRIBUTING INFORMATION THROUGHOUT AN AIRCRAFT”, by Robert V. Troxel et al., discloses a passenger entertainment system of an aircraft utilized to distribute audio and/or video in a digital formal throughout a vehicle. The system includes an Asynchronous Transfer Mode (“ATM”) network interconnected to a high speed, serial distribution network for propagating information in a predetermined format. The ATM network supports the broadcast of audio and/or video in real-time as well as actual “video on-demand” services. U.S. Pat. No. 6,108,523, issued Aug. 22, 2000, entitled “WIRELESS, FREQUENCY-AGILE SPREAD SPECTRUM GROUND LIKED-BASED AIRCRAFT DATA COMMUNICATION SYSTEM WITH REMOTE FLIGHT OPERATIONS CONTROL CENTER”, by Thomas H. Wright et al., discloses a flight information communication system having a number of RF direct sequence spread spectrum ground data links that link respective aircraft-resident subsystems with airport-located subsystems. The data links may be employed to upload in-flight data files, such as audio, video and navigation files from airport-located subsystems to the aircraft. A stated purpose of the system is to facilitate the analysis of flight performance data by aircraft safety professionals.

As shown in the conventional systems described above, the use of data and information systems on-board passenger vehicles is known. Such systems may be utilized to support communication of data between devices connected to the system such as, for example a file and/or data server and personal electronic devices (PEDs) such as, for example, laptop computers operated by passengers on-board the vehicle. To date, however, communication on-board passenger vehicles has been substantially limited to systems having hard wired communication connections installed in the bulkhead of the vehicle with system connections made available for PEDs in passenger seat backs.

The inventors have realized that a data management system for passenger transportation vehicles that utilizes a wireless communication network offers some additional benefits to the conventional systems described above. For example, wireless communication technology has eliminated the restriction placed on mobility by wired networks. In addition to increasing mobility of users of such technology, wireless network connections offer connectivity without the need for expensive wiring or rewiring to physically connect devices since wireless networks permit connectivity without such direct wiring. This is particularly beneficial in areas such as on-board aircraft, where space and weight factors must be considered for all installed systems. Additionally, modifications to electrical systems on-board certain transportation vehicles must be approved by governmental agencies to ensure specific safety and other standards are met. As devices used in personal and business computing become more varied, the need for modifications to data and electrical systems to service such devices may become more frequent.

Accordingly, the inventors have realized that a data management system for transportation vehicles that includes a wireless communication network significantly improves the flexibility of system to support and service ever changing data needs of current and future travelers.

### OBJECTS OF THE INVENTION

Therefore, it is an object of this invention to provide an improved data management system for transportation vehicles that includes a wireless communication network.

It is another object of this invention to provide a wireless entertainment system on-board transportation vehicles such that particular data content is distributed to a passenger upon request.

Further objects of this invention will become more apparent from a consideration of the drawings and ensuing description.

### SUMMARY OF THE INVENTION

The foregoing objects are realized by methods and apparatus in accordance with embodiments of this invention, wherein a wireless communication system for a transportation vehicle such as, for example, an aircraft, bus, cruise ship, and train includes an information source containing data content including text, audio and video media, a plurality of wireless interfaces, a plurality of individually identifiable electronic devices coupled to the plurality of wireless interfaces and a wireless local area network (LAN) access point. The wireless LAN access point is coupled to the information source and wirelessly coupled to the plurality of wireless interfaces. In operation, the wireless LAN access point receives data content from the information source, converts the data content into a wireless transmission format and selectively distributes the formatted data content to the plurality of wireless interfaces such that the formatted data content is accessible by at least a selected one of the plurality of individually identifiable electronic devices.

In one embodiment, wireless transmission within the communication system between vehicle components and personal electronic devices on-board the transportation vehicle is conducted in accordance with data transmission protocols such as, for example, IEEE-802.11 Wireless LAN Medium Access Control and Physical Layer Specification, including IEEE-802.11a, IEEE-802.11b, and IEEE-802.11g standards and IEEE-802.15 Wireless Personal Area Networks Access Method and Physical Layer Specification and each vehicle component and personal electronic device conforms to standards defined under DO-160D, Environmental Conditions and Test Procedures for Airborne Equipment.

In another embodiment, wireless transmission within the communication system between a first subset of vehicle components and personal electronic devices on-board the transportation vehicle is bidirectional while wireless transmissions between a second subset of vehicle components and personal electronic devices is unidirectional (e.g., from a wireless LAN access point to each of the second subset of devices). In yet another embodiment, wireless transmission within the communication system between all vehicle components and personal electronic devices is bi-directional.

### BRIEF DESCRIPTION OF THE DRAWINGS

The above set forth and other features of the invention are made more apparent in the ensuing Detailed Description of the Preferred Embodiments when read in conjunction with the attached Drawings, wherein:

FIG. 1 illustrates a top plan view of a transportation vehicle cabin employing a wireless data management system constructed and operating in accordance with one embodiment of the present invention;

FIG. 2 is a simplified block diagram of the wireless data management system of FIG. 1;

FIG. 3 is a simplified block diagram of a wireless video display unit constructed and operating in accordance with one embodiment of the present invention;

FIGS. 4a and 4b are simplified block diagrams of wireless interface units, constructed and operating in accordance with one embodiment of the present invention, for coupling personal computing devices to a wireless data management system of the present invention; and

FIG. 5 is a simplified block diagram of a wireless passenger control unit, constructed and operating in accordance with one embodiment of the present invention, for selecting and controlling video and audio content presented to passengers.

### DESCRIPTION OF THE PREFERRED EMBODIMENTS OF THE INVENTION

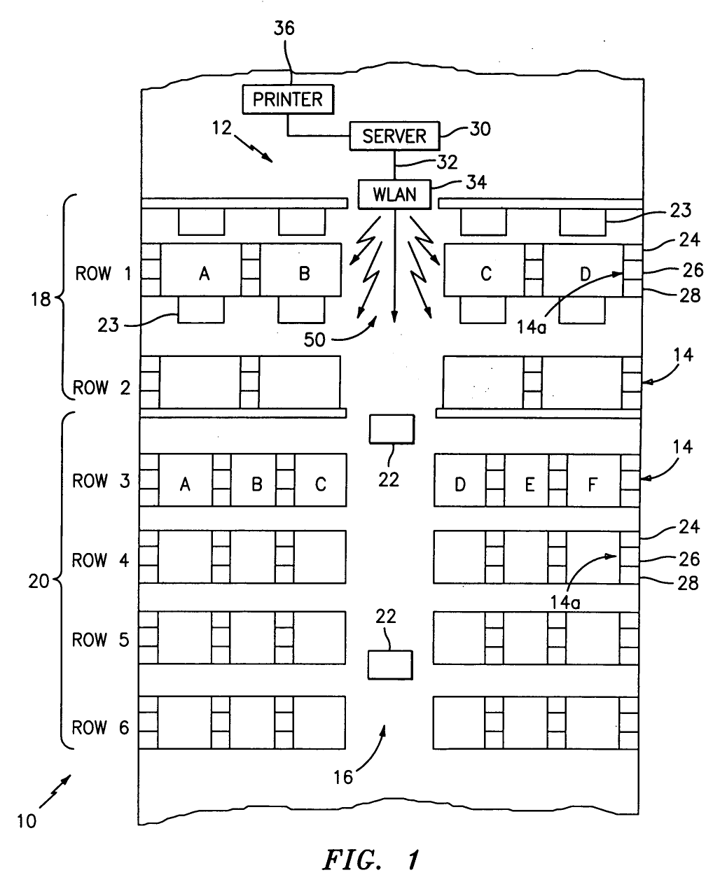

FIG. 1 illustrates in top planar view a portion of a transportation vehicle cabin 10 (e.g., an aircraft fuselage, cabin, car or compartment of a bus, train or subway, or the like) utilizing a wireless data management system 12 of the present invention. Contained within the cabin 10 is a plurality of seats, shown generally at 14, arranged in, for example, columns and rows. As shown in FIG. 1, each seat 14 in the vehicle cabin 10 is identifiable by, for example, a combination of a column and row number (e.g., 1A, 1B, . . . , 3A, 3B, 3C, . . . ). Respective columns of plurality of seats 14 are separated by, for example, one or more cabin walkways 16. In one embodiment, a predetermined number of rows of seats may be configured to form one or more groups or classes of seating, e.g., classes 18 and 20. As is presently available within conventional transportation vehicle cabins, different seat sizes, levels of service and/or entertainment and business systems are offered to persons within certain of the classes of seating. It should be appreciated that one or more features and functions of the present invention can be made selectively available at certain of the classes of seating.

It should also be appreciated that while described in terms of use aboard a transportation vehicle, the present invention may be utilized on more than passenger transportation vehicle such as, for example, aircraft, buses, ships, trains, vans and any other air, land and water vehicle capable of carrying a plurality of passengers. For example, it should be appreciated that the wireless data management system of the present invention may be employed in venues that would benefit from wireless transmission of data content to individually identifiable end-users such as auditoriums, class rooms, hotels, movie theatres and like environments.

In accordance with the present invention, the wireless data management system 12 distributes, via communication signals shown generally at 50, data content such as, for example, digitized media (video and audio) to a plurality of passenger devices and a plurality of entertainment components such as, for example, wireless video displays 22, located within the transportation vehicle cabin 10. The data content includes, for example, Intranet, Internet, E-mail data and the digitized media includes, for example, digital video (MPEG1, MPEG2) and digital audio (MPEG3) data.

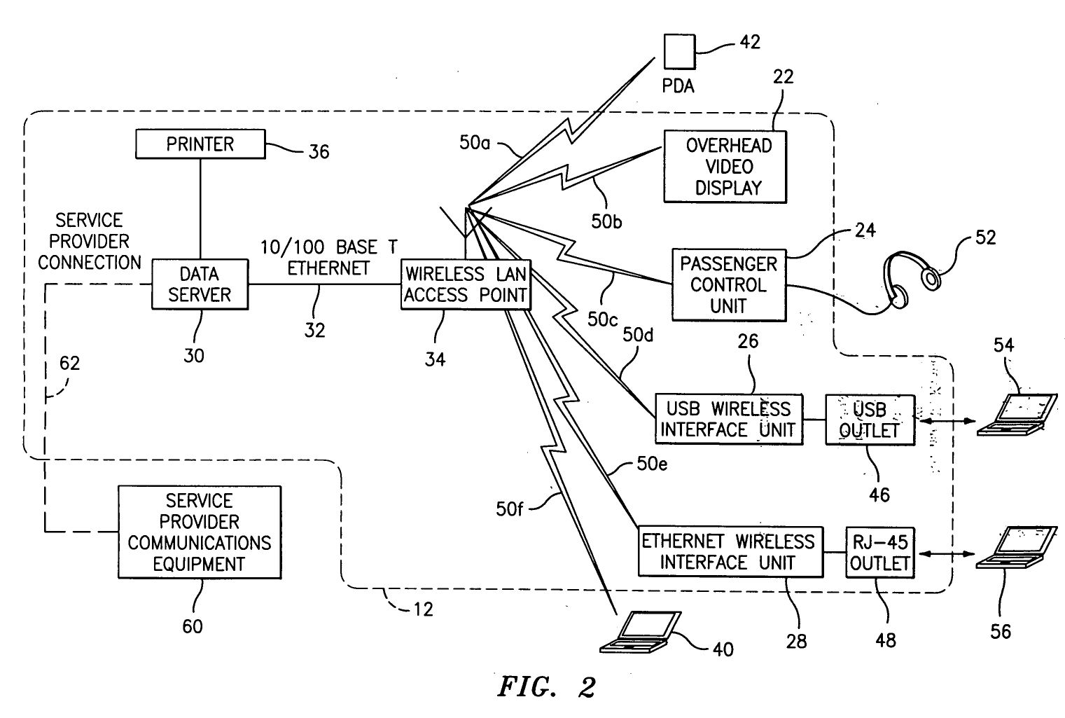

FIG. 2 illustrates a simplified block diagram of the wireless data management system 12 configured and operated, in accordance with the present invention, for selectively distributing data content to a plurality of devices, e.g., passenger devices and entertainment components, within the transportation vehicle cabin 10. In one embodiment, the data content is stored locally at a data server 30. In another embodiment, the data content is converted to digital formats and streamed through the data server 30 in real-time to the passenger devices and entertainment components on-board the transportation vehicle.

As shown in FIG. 2, the data server 30 is coupled to a wireless local area network (WLAN) access point 34 through a serial or parallel communication connection 32 such as, for example, a 10/100 Base T Ethernet connection. The WLAN access point 34 converts data content received from the data server 30 into a suitable format for wireless transmission in accordance with data transmission protocols such as, for example, IEEE-802.11 Wireless LAN Medium Access Control and Physical Layer Specification, including IEEE-802.11a, IEEE-802.11b, and IEEE-802.1 μg standards and IEEE-802.15 Wireless Personal Area Networks Access Method and Physical Layer Specification. The disclosures of data transmission protocols IEEE-802.11, IEEE-802.11a, IEEE-802.11b, IEEE-802.11g and IEEE-802.15 are incorporated by reference herein in their entireties. The aforementioned standards define protocols and compatible interconnections of data communication equipment via “air” signals (e.g., radio frequency and/or infrared signals) in a LAN using a carrier sense multiple access protocol with collision avoidance (CSMA/CA) medium sharing mechanism. Medium access control (MAC) supports operation under control of an access point as well as between independent stations. The protocols provide, for example, authentication, association and reassociation services, encryption/decryption procedures, power management and a point coordination function for the wireless transfer of data. Accordingly, the present invention may be utilized in systems employing these and other appropriate standards for wireless connectivity of fixed, portable and moving stations within a LAN.

Data content is transmitted by the WLAN access point 34 to wireless components fixed within the transportation vehicle cabin 10 such as, for example, wireless video display unit 22, wireless passenger control units 24, wireless interface units 26 and 28, and directly to passenger personal computing devices (e.g., PEDs) having compliant wireless interfaces such as, for example, wireless-enabled laptops 40, consumer electronics such as cell phones, pagers and personal digital assistants (PDAs) 42. It should be appreciated that the data transmission between the WLAN access point 34 and the aforementioned wireless devices may be by way of radio frequency (RF) and/or infrared (1R) signals, illustrated in FIGS. 1 and 2 as lines 50a-50f. It should also be appreciated that such data transmission in the passenger transportation vehicle cabin 10 is conducted in accordance with applicable communications standards aboard such vehicles such as is defined in, for example, DO-160D, Environmental Conditions and Test Procedures for Airborne Equipment. The DO-160D standard provides procedures and environmental test criteria for testing airborne electronic equipment. For example, DO-160D includes tests covering vibration, power input, RF susceptibility (radiated and conducted), lighting and electrostatic discharge. The DO-160D standard is incorporated by reference herein in its entirety. Accordingly, any device that is not complaint with DO-160D, or a similar standard in another country, is denied access to the wireless data management system 12.

In one embodiment data communication between the WLAN access point 34 and the wireless video display unit 22, wireless passenger control unit 24 and wireless interface units 26 and 28 (e.g., over lines 50b-50e) is bidirectional, while data communication between the WLAN access point 34 and the passenger personal computing devices, e.g., wireless-enabled laptops 40, cell phones and PDAs 42 (e.g., over lines 50a and 50f) is unidirectional. Such a configuration provides for bidirectional communication between fixed network access points that substantially eliminates, for example, undesired transmissions within the vehicle cabin 10 that may cause interference with vehicle command and control systems. In another embodiment, data communication (e.g., over lines 50a-50f) between the WLAN access point 34 and the wireless video display unit 22, wireless passenger control unit 24, wireless interface units 26 and 28 and passenger personal computing devices (e.g., devices 40 and 42) is bidirectional. In this configuration, bidirectional communication is present from both fixed and non-fixed access points.

In accordance with the present invention, the data server 30 provides the wireless data management system 12 functions for distributing, converting and storing data content such that particular data content may be requested and delivered to passengers individually (on a seat by seat basis), within predetermined classes (within one or more classes 18 and 20 of the vehicle cabin 10), or to all passengers in general. In one embodiment, the data server 30 is coupled to an external service provider communications device 60 over a serial or parallel interface (illustrated in FIG. 2 as line 62) such as, but not limited to, Ethernet (IEEE-802.3), RS-485, and CEPT-EL. The external service provider communications device 60 may, in turn, be coupled to a global communications network such as, for example, the Internet, and/or a private network such as an intranet or extranet. As such, data server 30 may access data content made available to the service provider communications device 60 from anywhere in the world.

In one embodiment, the data server 30 contains interfaces for connecting to video and audio reproduction equipment (not shown) and to convert standard analog video and audio signals to digital formats or distribute digitally formatted video and audio content to passengers. It should be appreciated that the present invention contemplates use of the data management system 12 for video conferencing between passengers and persons at other locations.

In another embodiment, the data server 30 is connected to peripheral devices such as, for example, a printer 36 or like output devices. Passengers within the vehicle cabin 10 may wirelessly transmit data from electronic devices such as laptop 54 to the WLAN access point 34 for output on the printer 36. As such, the WLAN access point 34 is a gateway allowing wireless access to real-time services provided by the data server 30 such as, for example, printing, downloading and viewing email messages, file sharing, gaming, Internet access and other modem-assisted telecommunication functions.

The WLAN access point 34 interfaces with the data server 30 and, in one embodiment (not shown), is contained within the data server 30. Alternatively, the WLAN access point 34 is a separate component connected to the data server 30 through the communication connection 32 (as shown in FIGS. 1 and 2). The WLAN access point 34 receives data transmitted over the communication connection 32 buffers, converts and transmits signals (e.g., RF or IR signals) using data transmission protocols such as, for example, defined in IEEE-802.11 including, e.g., IEEE-802a, IEEE-802.11b, and IEEE-802.11g, and/or IEEE-802.15. In one embodiment, the transmission signals are encrypted and transmitted via internal or external antenna(s) within the cabin 10 of the transportation vehicle for reception by wireless video display units 22, wireless passenger control units 24, wireless interface units 26 and 28, and directly to the wireless-enabled passenger laptops 40, consumer devices such as cell phones, pagers and PDAs 42. It should be appreciated that the present invention provides a conduit for such communication that utilizes application layer message formats and/or routing identifiers (e.g., unique identifier for each electronic device within the system 12) as described in, for example, the aforementioned wireless communication standards IEEE-802-11 and IEEE-802.15.

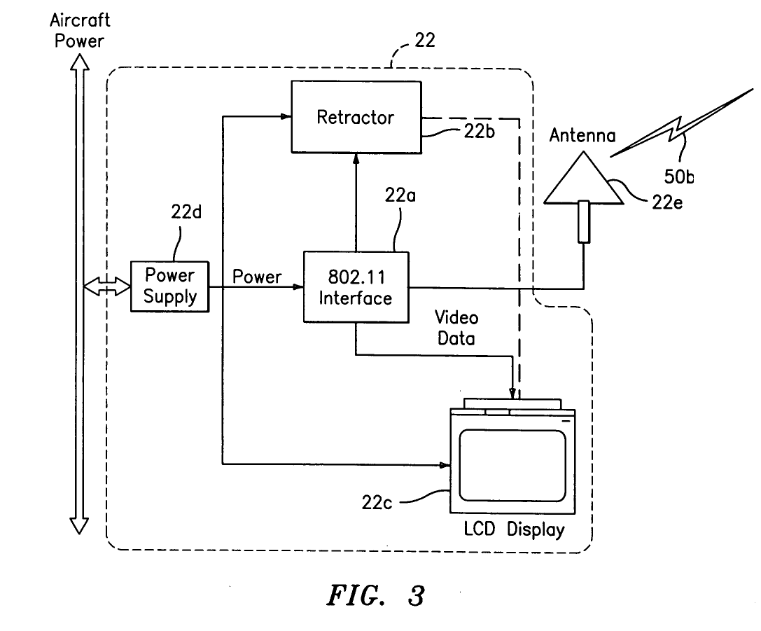

As shown in FIG. 3, the wireless video display unit 22 receives via antenna 22e video data content from the WLAN access point 34 for displaying the video content to passengers within the vehicle cabin 10. The video display unit 22 includes a wireless LAN compliant interface 22a for receiving and transmitting wireless data using data transmission protocols such as, for example, IEEE-802.11 including IEEE-802.11a, IEEE-802.11b and IEEE-802.11g, and/or IEEE-802.15. The wireless video display unit 22 receives wireless data content and converts it to be displayed on a display device 22c such as a liquid crystal display (LCD) or Gas Plasma display. Preferably, the wireless video display unit 22 may include a retractor 22b that is controlled via the wireless interface 22a. The retractor 22b moves the display device 22c between a stored position (not shown) and a deployed position (shown).

In one embodiment, the vehicle cabin 10 includes a plurality of wireless video display units strategically located within the vehicle so that numerous passengers may view an individual display unit 22 and the video content presented thereon. In another embodiment, a plurality of wireless video display units 23 (similar to wireless video display unit 22) are positioned for viewing by individual passengers such as, for example, in seatbacks or other locations in proximity to each individual passenger seat (see FIG. 1). Such individual wireless video display units 23 may not include the aforementioned retractor 22b.

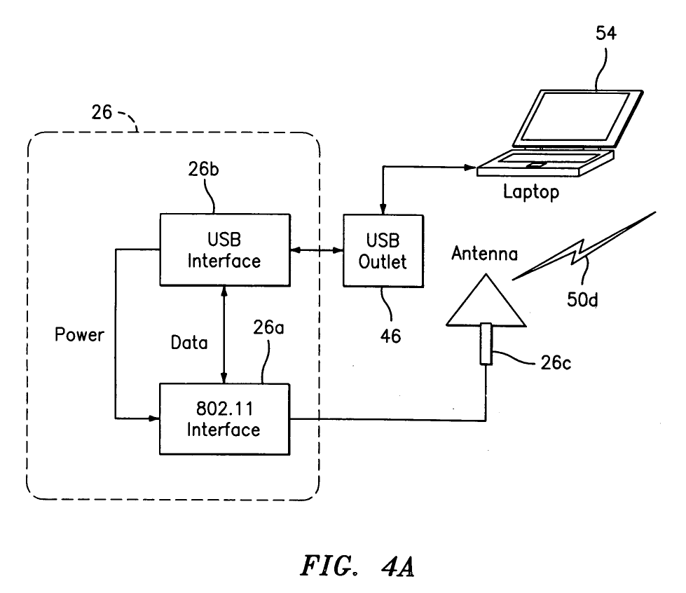

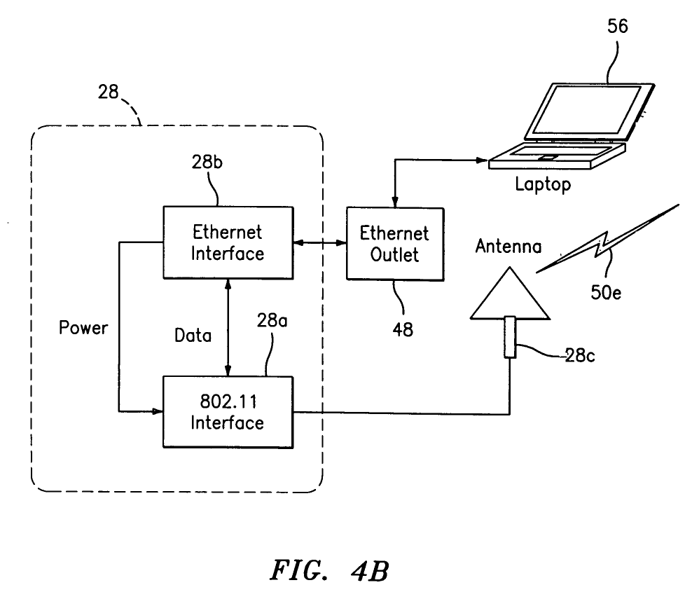

FIGS. 4A and 4B illustrate the wireless interface units 26 and 28, respectively. The wireless interface units 26 and 28 are mounted within the vehicle cabin 10 and permit an exchange of data between the WLAN access point 34 and passenger devices such as, for example, laptops, consumers electronics including, for example, cell phones, pagers and PDAs. As such, the wireless interface units 26 and 28 receive and transmit data including requests from passenger devices for particular data content and the data content delivered from the WLAN access point 34. Preferably, the wireless interface units 26 and 28 are of one of two types, in combination or singularly:
1. The wireless interface unit 26 that converts data received from the WLAN access point 34 by antenna 26c to/from USB protocols and provides a USB type connector 46 for passenger devices (e.g., laptop 54 of FIG. 2) connectivity; and
2. The wireless interface unit 28 that converts data received from the WLAN access point 34 by antenna 28c to/from Ethernet protocols and provides an RJ-45 type connector 48 for passenger devices (e.g., laptop 56 of FIG. 2) connectivity.

In one embodiment (FIG. 1), the wireless interface units 26 and 28 are mounted in a portion, shown generally at 14a, of a passenger seat 14 and can be powered externally (not shown) or by the passenger device such as, e.g., by a passenger laptop or PDA device (FIGS. 4A and 4B). Alternatively, the wireless interface units 26 and 28 are located near each seat 14, e.g., in a housing located under a seat 14. The wireless interface units 26 and 28 include a wireless LAN compliant interface 26a and 28a, respectively, for receiving and transmitting wireless data using data transmission protocols such as described in, for example, IEEE-802.11 including IEEE-802.11a, IEEE-802.11b and IEEE-802.11g, and/or IEEE-802.15 standards. The wireless interface units 26 and 28 include a data converter/transceiver unit 26b and 28b, respectively. The converter/transceiver units 26b and 28b are coupled to outlet units 46 and 48, respectively. The outlet units 46 and 48 connect the wireless interface units 26 and 28 to personal computing devices, e.g., the laptops 54 and 56.

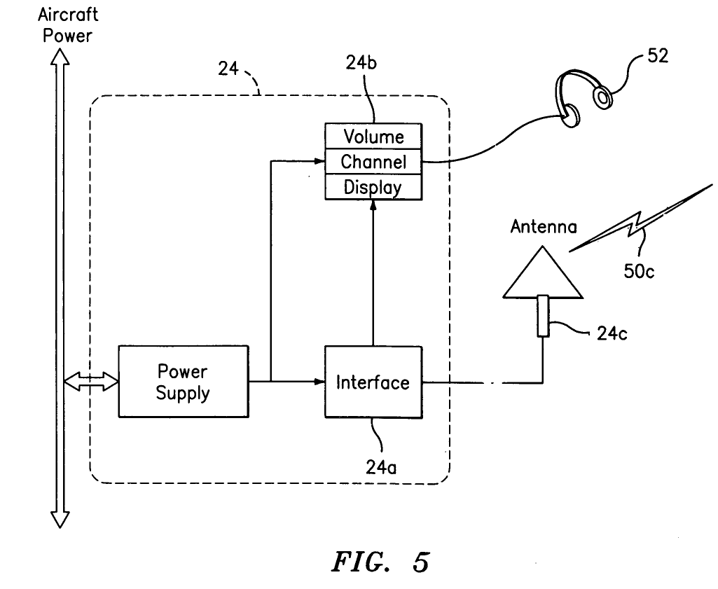

FIG. 5 illustrates a wireless passenger control unit 24. The wireless passenger control unit 24 includes a wireless compliant interface 24a for receiving/transmitting data from/to the WLAN access point 34 via antenna 24c. The passenger control unit 24 converts digitally formatted audio data content to, for example, stereo analog audio signals and provides a passenger with controls 24b to, for example, adjust volume level and select audio channels. In one embodiment, the passenger control unit 24 includes controls and a display so that a passenger may select video and audio content to be provided by the WLAN access point 34 and presented at the passenger control unit 24. In another embodiment, a stereo mini-jack is provided for connecting an audio listening device (e.g., headphones 52) to the passenger control unit 24. Preferably, the wireless passenger control unit 24 is mounted to the portion 14a of each passenger seat 14.

Although described in the context of preferred embodiments, it should be realized that a number of modifications to these teachings may occur to one skilled in the art. By example, and as discussed above, the teachings of this invention are not intended to be limited to any specific transportation vehicle, that is, the invention may be utilized with equal success on aircraft, buses, ships, trains and any vehicles transporting passengers having a need or desire to access electronic information such as text, audio and video content. Additionally, the teachings of the present invention may be employed in other venues such as, for example, auditoriums, hotels, movie theatres and the like.

While the invention has been particularly shown and described with respect to preferred embodiments thereof, it will be understood by those skilled in the art that changes in form and details may be made without departing from the scope and spirit of the invention.

1. A wireless communication system for a transportation vehicle, comprising:
an information source containing data content;
a plurality of wireless interfaces, each wireless interface fixed in the transportation vehicle and conforming to airborne environmental requirements, configured to wirelessly communicate with the information source;
a plurality of individually identifiable electronic devices, each individually identifiable electronic device configured to communicate with the information source; and
a wireless local area network access point coupled to said information source and wirelessly coupled to said plurality of wireless interfaces, said wireless LAN access point for receiving data content from said information source, converting said data content into a wireless transmission format conforming to airborne environmental requirements and permitting access to the formatted data content only through the plurality of wireless interfaces, wherein each individually identifiable electronic device is wirelessly coupled to a respective wireless interface to communicate with the information source.

2. The wireless communication system as set forth in claim 1, wherein said information source comprises a data server fixedly coupled to said transportation vehicle and logically coupled to an external service provider communication device.

3. The wireless communication system as set forth in claim 1 wherein said plurality of wireless interfaces comprise at least one wireless interface fixedly coupled in said transportation vehicle and at least one wired interface fixedly coupled within one of said plurality of individually identifiable electronic devices.

4. The wireless communication system as set forth in claim 1 wherein said wireless LAN access point selectively distributes said formatted data content by routing said data content to the wireless interfaces supporting selected one of said plurality of individually identifiable electronic devices.

5. The wireless communication system as set forth in claim 1 wherein said communication system supports bidirectional communication between said information source and said plurality of individually identifiable electronic devices such that one of said plurality of individually identifiable electronic devices may request delivery of specific data content from said information source.

6. The wireless communication system as set forth in claim 1 wherein said communication system supports bidirectional communication between said information source and a first subset of said plurality of individually identifiable electronic devices and unidirectional communication between said information source and a second subset of said plurality of individually identifiable electronic devices.

7. The wireless communication system as set for the in claim 1 wherein said plurality of individually identifiable electronic devices include a wireless video display unit.

8. The wireless communication system as set forth in claim 7 wherein said wireless video display unit is comprised of a video display unit for presenting video content to a plurality of passengers.

9. The wireless communication system as set forth in claim 7 wherein said wireless video display unit is comprised of a plurality of video display units for presenting video content to individual ones of a plurality of passengers.

10. The wireless communication system as set forth in claim 9 wherein said plurality of video display units are located within seatback units.

11. The wireless communication system as set forth in claim 1 wherein said plurality of wireless interfaces include an airborne environmental complaint interface fixedly coupled in a passenger control unit, said airborne environmental compliant interface for receiving data from and transmitting data to said wireless LAN access point.

12. The wireless communication system as set forth in claim 1 wherein said plurality of wireless interfaces include a passenger control unit having a plurality of controls and a display, said passenger control unit operable by a passenger for selecting and controlling one of video content, audio content, and combinations thereof.

13. The wireless communication system as set forth in claim 12 wherein said passenger control unit includes a connector for connecting an audio listening device, and wherein a passenger selects audio content accessible at said passenger control unit by said audio listening device.
